(19) United States
(12) Patent Application Publication
(10) Pub. No.: US 2011/0095564 A1
(43) Pub. Date: Apr. 28, 2011

(54) NOZZLE-TYPED DRAG-REDUCING STRUCTURE FOR VEHICLE

(76) Inventor: Shih Hsiung CHEN, Yongkang City (TW)

(21) Appl. No.: 12/604,754

(22) Filed: Oct. 23, 2009

(51) Int. Cl. B62D 37/02

(52) U.S. Cl. 296/180.4

(57) ABSTRACT

A nozzle-typed drag-reducing structure for vehicle is arranged at the tail end of a vehicle, including a frame body comprised of a combination of a plurality of deflectors, between two of which an airflow channel is formed; and an air inlet and an air outlet respectively formed at two sides of the frame body, and the area comprised by surrounding the air outlet is larger than the area comprised by surrounding the air inlet. Thereby, whenever the vehicle is driven in high speed or low speed, it is all possible to boost the running efficiency and increase the driving stability.

### BACKGROUND OF THE INVENTION

1. Field of the Invention

The present invention in general relates to a drag-reducing structure, in particular, to a nozzle-typed drag-reducing structure for vehicle.

2. Description of Prior Art

When driven on road, the running efficiency of a common vehicle is usually influenced by the drag force of the surrounding airflow. The most common manner is to arrange deflector to solve this kind of problem. In particular, it is more necessary for a large vehicle to install reflector, when running in a long distance. Because a large vehicle is heavier and larger than a small vehicle, so the large vehicle usually has a poor efficiency in terms of fuel consumption, compared with the small vehicle, during a long time and a long distance running, because of the drag problem, which further loads a larger amount of cost burden onto the industry, who runs the transportation business.

According to prior arts, as disclosed by Taiwan Patent No.: M329580 of Taiwan patent certification, a diversion structure for vehicle mainly includes: a frame body comprised of a plurality of deflectors correspondingly, between two of which an airflow channel is formed; and an air inlet and an air outlet respectively arranged at two sides of the frame body and communicated with the airflow channel. In this structure, the area of the air inlet is larger than that of the air outlet.

However, according to this kind of diversion structure for vehicle, only when the running speed of the vehicle is higher than a specific value, an airflow pressure is then generated sufficiently to form a jet flow possessing acceleration function at the air outlet. By so doing, an invisible air wall is formed to further reduce the magnitude and the strength of the airflow at the tail end of the vehicle, whereby an effect of drag reduction is thus achieved. But, there is one problem existed; namely, if the running speed of the vehicle is lower than the specific value, then the dynamic energy of the airflow is too low to pass through the frame body. In other words, the capability of the airflow to form the air wall is weakened, so it is impossible to reduce the eddy strength in a large scale and effectively, whereby the drag can not be reduced significantly, which is an issue needed to be addressed by the relative industry urgently.

Accordingly, after a substantially devoted study, in cooperation with the application of relative academic principles, the inventor has finally proposed the present invention designed reasonably to possess the capability to improve the drawbacks of the prior arts significantly.

### SUMMARY OF THE INVENTION

Therefore, in order to solve aforementioned problems, the invention is mainly to provide a nozzle-typed drag-reducing structure for vehicle, which can effectively guide the airflow passing around the vehicle and significantly reduce the drag when the vehicle is running. According to the invention, the running efficiency of the vehicle is promoted and the driving stability of the vehicle is enhanced.

Secondly, the invention is to provide a nozzle-typed drag-reducing structure for vehicle, which is adapted by being arranged at the tail end of a vehicle and includes a frame body comprised of a combination of a plurality of deflectors, between two of which an airflow channel is formed; and an air inlet and an air outlet respectively formed at two sides of the frame body, and the area comprised by surrounding the air outlet is larger than the area comprised by surrounding the air inlet.

Compared with prior arts, the invention further possesses the following functions and merits. First of all, whenever the vehicle is running in high speed or low speed, it is all possible for the invention to effectively boost the running efficiency and enhance the driving stability. Secondly, since of a plurality of separating plates installed in the frame body, it is possible for each deflector to increase its capability to resist the deformation. Finally, by means of the connecting assembly to be combined with the vehicle and the frame body, it is possible for the frame body to make adjustment by being swung relatively to the connecting assembly, which facilitates the rear door of the vehicle in processing the actions of open and close. Because of the assembling activation between the driving assembly and the connecting assembly, it can further enhance the operational convenience for the user.

### BRIEF DESCRIPTION OF DRAWING

The features of the invention believed to be novel are set forth with particularity in the appended claims. The invention itself, however, may be best understood by reference to the following detailed description, which describes a number of embodiments of the invention, taken in conjunction with the accompanying drawings, in which:

FIG. 1 is a perspective outer view of a drag-reducing structure according to the present invention;

FIG. 2 is a partially enlarging view of a drag-reducing structure according to the present invention;

FIG. 3 is a laterally side view of a drag-reducing structure according to the present invention;

FIG. 4 is a cross-sectional view of a drag-reducing structure according to the present invention at an activating status;

FIG. 5 is an assembled illustration of the present invention applied in a vehicle;

FIG. 6 is a using status illustration (1) of the present invention applied in a vehicle;

FIG. 7 is a using status illustration (2) of the present invention applied in a vehicle;

FIG. 8 is an assembled illustration of another embodiment of the present invention applied in a vehicle;

FIG. 9 is an assembled illustration of a further embodiment of the present invention applied in a vehicle; and

FIG. 10 is a perspective outer view of a drag-reducing structure according to another embodiment of the present invention.

### DETAILED DESCRIPTION OF THE INVENTION

In cooperation with attached drawings, the technical contents and detailed description of the present invention are described thereinafter according to a number of embodiments, not used to limit its executing scope. Any equivalent variation and modification made according to appended claims is all covered by the claims claimed by the present invention.

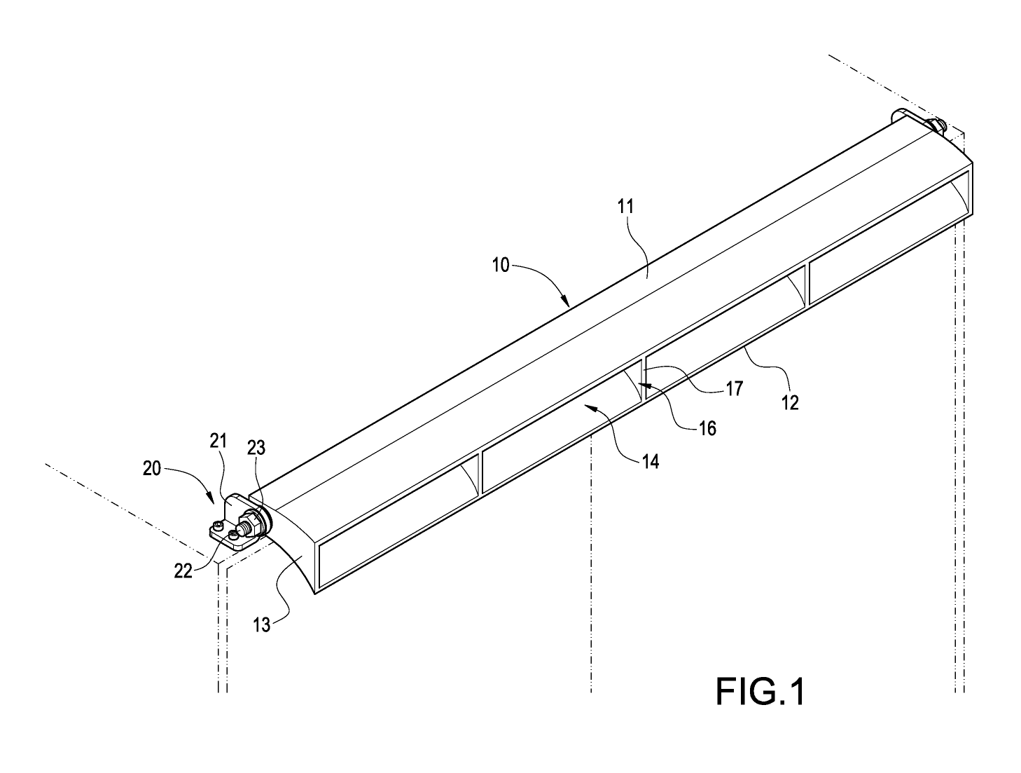

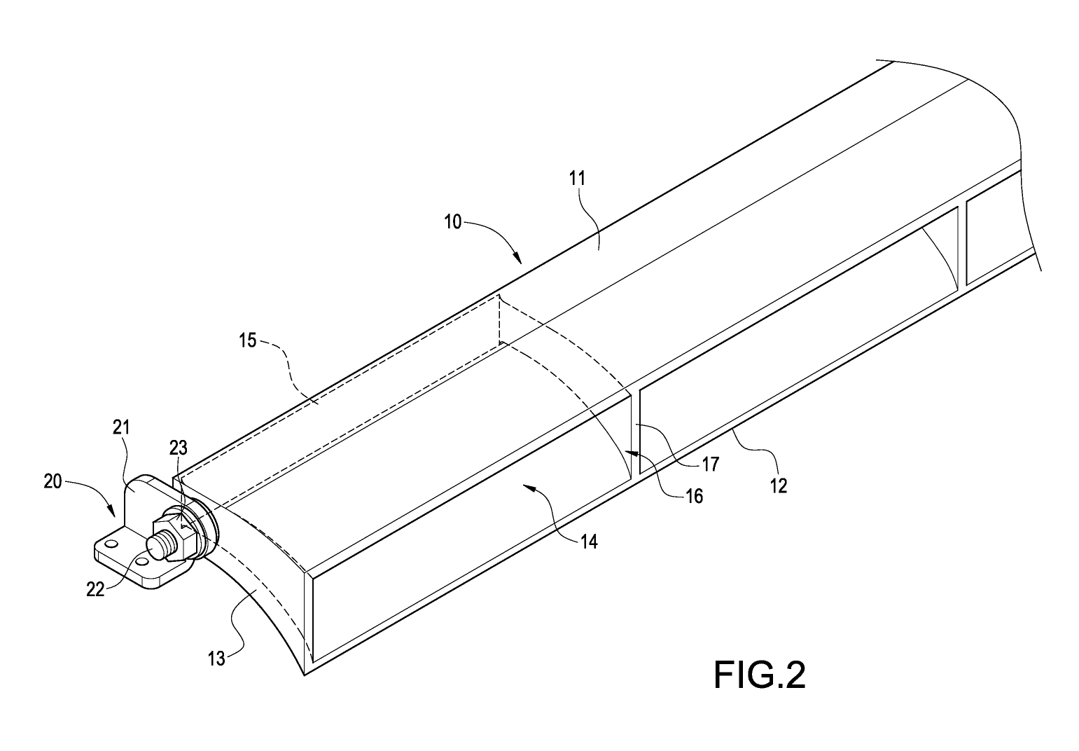

Please refer to FIG. 1 through FIG. 3, which show a nozzle-typed drag-reducing structure for vehicle according to the present invention, mainly including a frame body 10 and a pair of connecting assemblies 20.

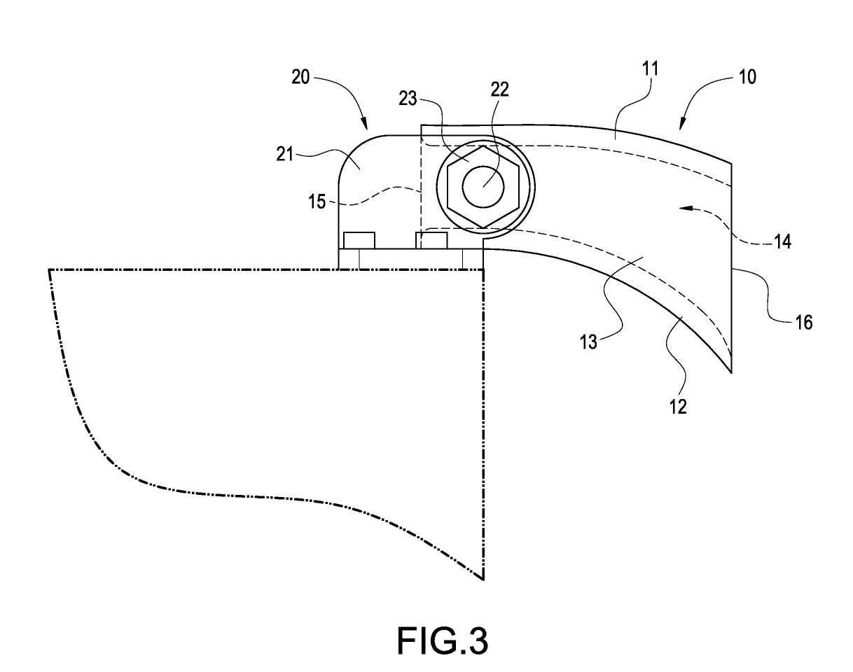

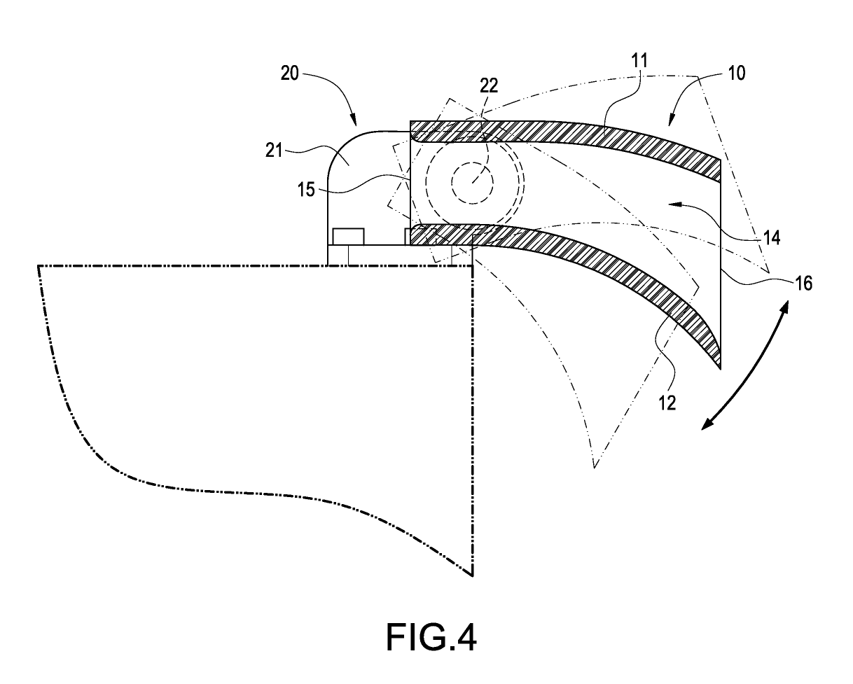

The frame body 10 is integrally comprised of an upper deflector 11, a lower deflector 12 and two lateral deflectors 13. The upper and lower deflectors 11, 12 are all shown as an arc configuration individually, while the lateral deflectors 13 are shown as a vertical configuration respectively and interconnected with the upper and lower deflectors 11, 12. In addition, an airflow channel 14 is formed among each reflectors 11, 12 and each lateral reflectors 13. In this case, an air inlet 15 and an air outlet 16, both of which are communicated with the airflow channel 14, are respectively formed at the front and rear sides of the frame body 10. By designing the curvature radius of the upper deflector 11 to be larger than that of the lower deflector 12, as shown in FIG. 3 and FIG. 4, the sectional area comprised by surrounding the air outlet 16 is larger than the sectional area comprised by surrounding the air inlet 15.

The connecting assembly 20 mainly includes an “L”-shaped angular plate 21, a pivot 22 and a locking element 23. The “L”-shaped angular plate 21 is arranged a through hole (not shown in the figures) provided for the pivot 22 to pass through. The pivot 22 of this embodiment is a screw, one side of which is inserted into the lateral deflector 13 and fixed thereto. In this case, the locking element 23 is a nut, which is connected by screwing with the pivot 22 correspondingly, such that the “L”-shaped angular plate 21 is forced tightly by being wedged at front of the lateral deflector 13.

Additionally, the frame body 10 of the invention further includes a plurality of separating plates, which are disposed in parallel to the lateral defectors 13 and are interspaced to each other by being accommodated in the airflow channel 14, whereby the capability of the upper and lower deflectors 11, 12 to resist the deformation is thus enhanced.

As shown in FIG. 4, to satisfy different requirements asked by various vehicles, the nozzle-typed drag-reducing structure of the invention pivots the connecting assembly 20 to the frame body 10, where the frame body 10 can be adjusted by being swung relatively to the assembly 20 in an upward and downward manner by taking the pivot 22 as a rotational center.

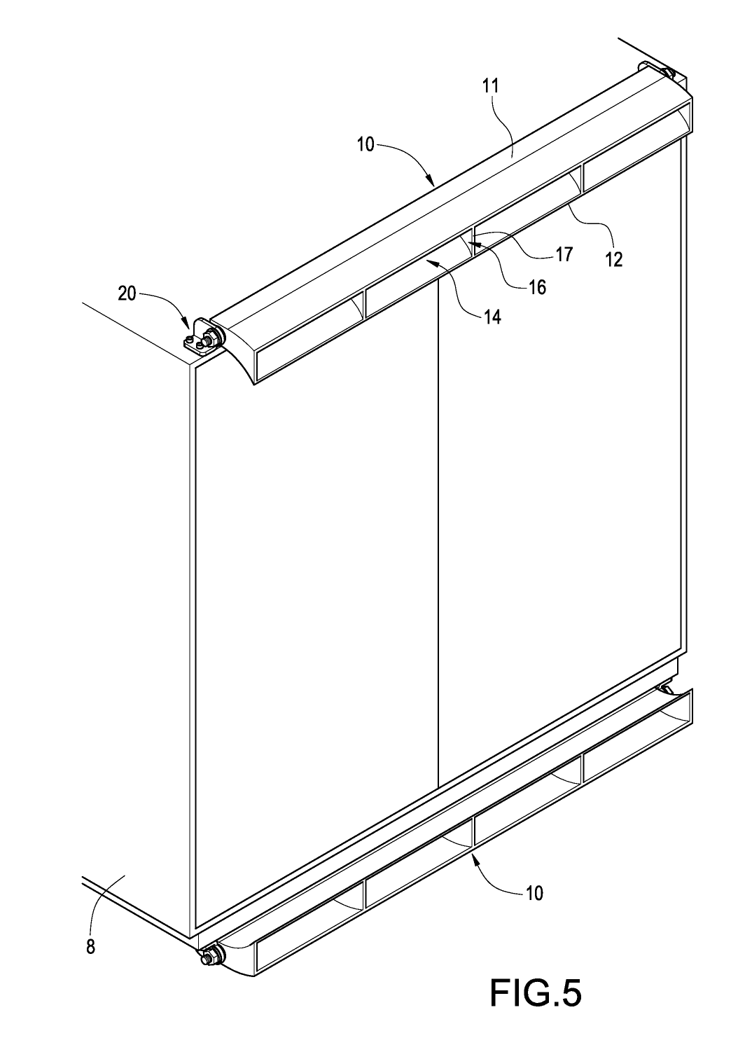

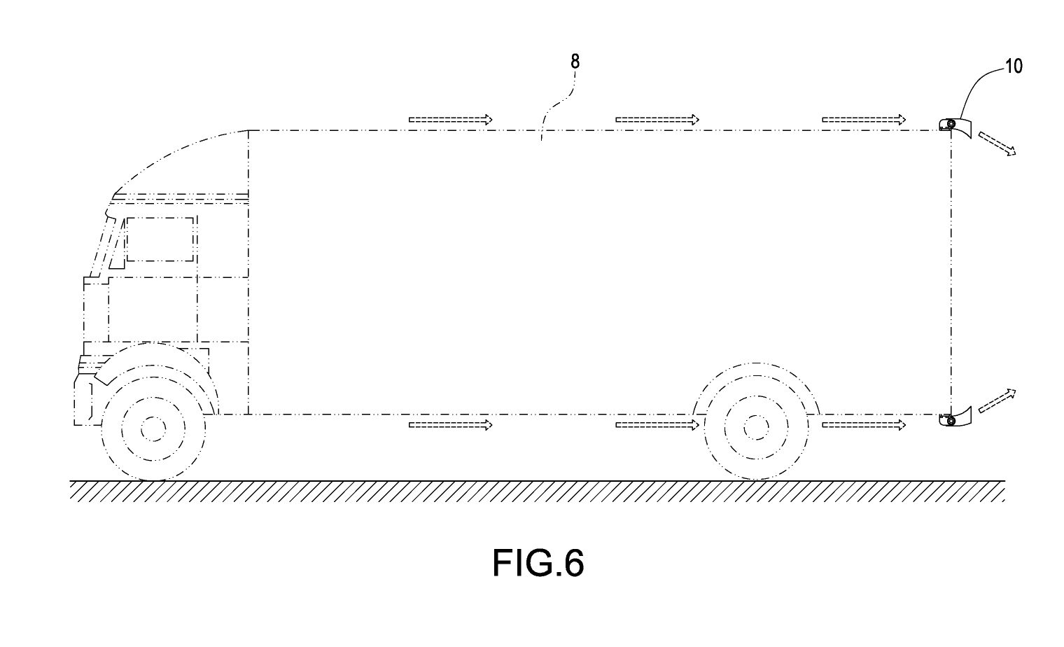

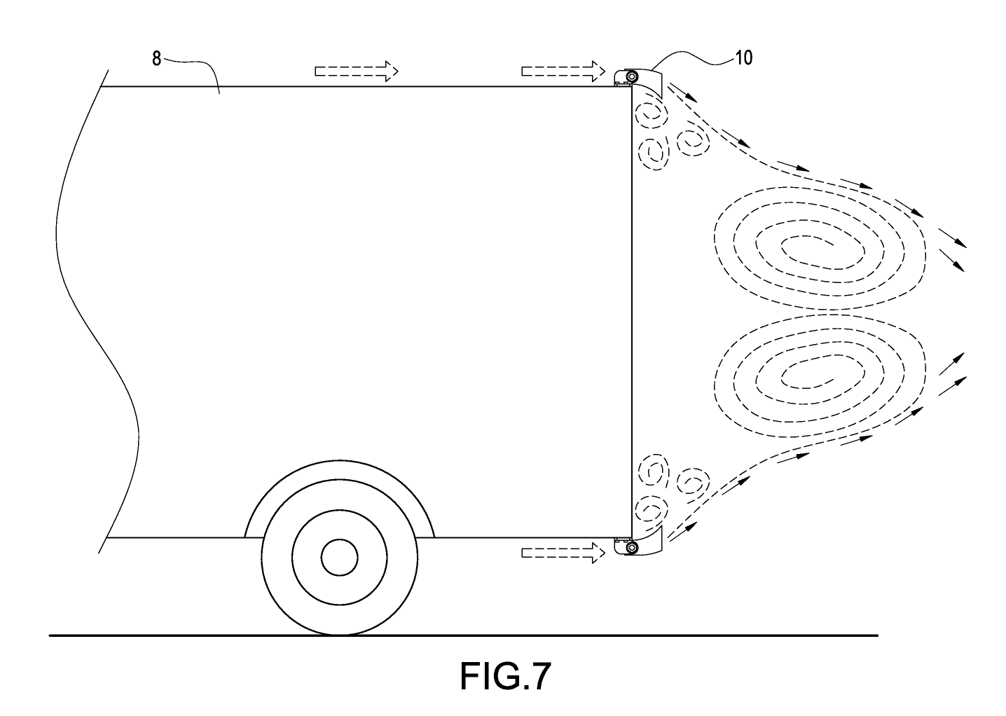

Please refer to FIG. 5 through FIG. 7. The nozzle-typed drag-reducing structure of the invention can be arranged by pair at the upper and lower positions of the tail ends of the vehicles 8, such as, truck or trailer, where threaded holes (not shown in the figures) are arranged at the vehicle 8 in advance, then the frame body 10 is combined to the vehicle 8 by passing the locking element, such as, screw, through the “L”-shaped angular plate 21.

During using, when the vehicle 8 is driven on the road, the airflow formed at its windward side (as shown by the arrows) will flow along the peripheral edges of the vehicle 8 and reaches the positions of the tail ends of the vehicle 8. This airflow enters the air inlet 15 from the front of the frame body 10 and exits from the air outlet 16 by following the flowing direction guided by the airflow channel 14 in the frame body 10. Since the area comprised by surrounding the air outlet 16 is larger than the area comprised by surrounding the air inlet 15, according to Bernoulli's principle, the airflow flowing in the airflow channel 14 will generate deceleration and pressure booster functions. Therefore, because of the pressure booster at the air outlet 16, when the airflow flows into the eddy zone at rear of the vehicle 8 where the pressure is low, it is easier for the airflow passing through the airflow channel 14 of the frame body 10 and the pressure loss of the airflow is also smaller. Moreover, having high pressure, biasing direction and large quantity, these airflows will all shrink the area of the eddy zone at rear of the vehicle 8 to boost its back pressure (according to prior practice, the low back pressure is the main cause for vehicle to generate great drag when driven forwardly), so it is easy for the vehicle 8 to achieve an effect of drag reduction. Besides, whenever the vehicle is driven in high speed or low speed, significant effect of drag reduction can be always existed to enhance the running efficiency of the vehicle 8.

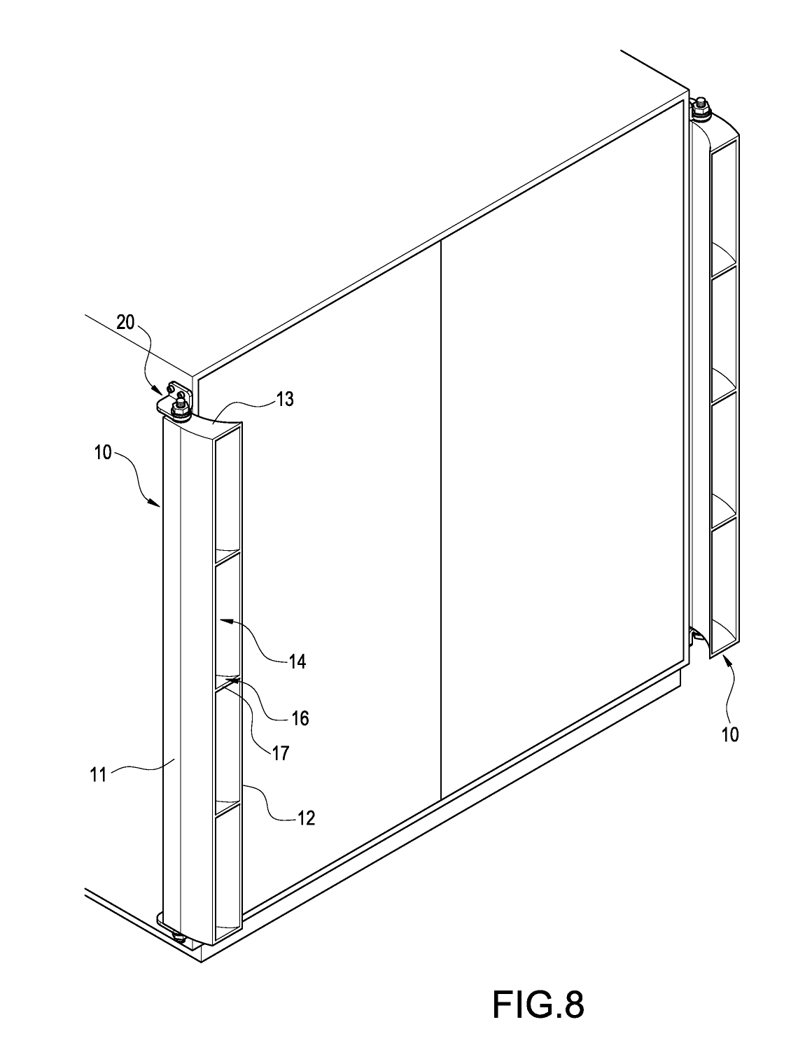

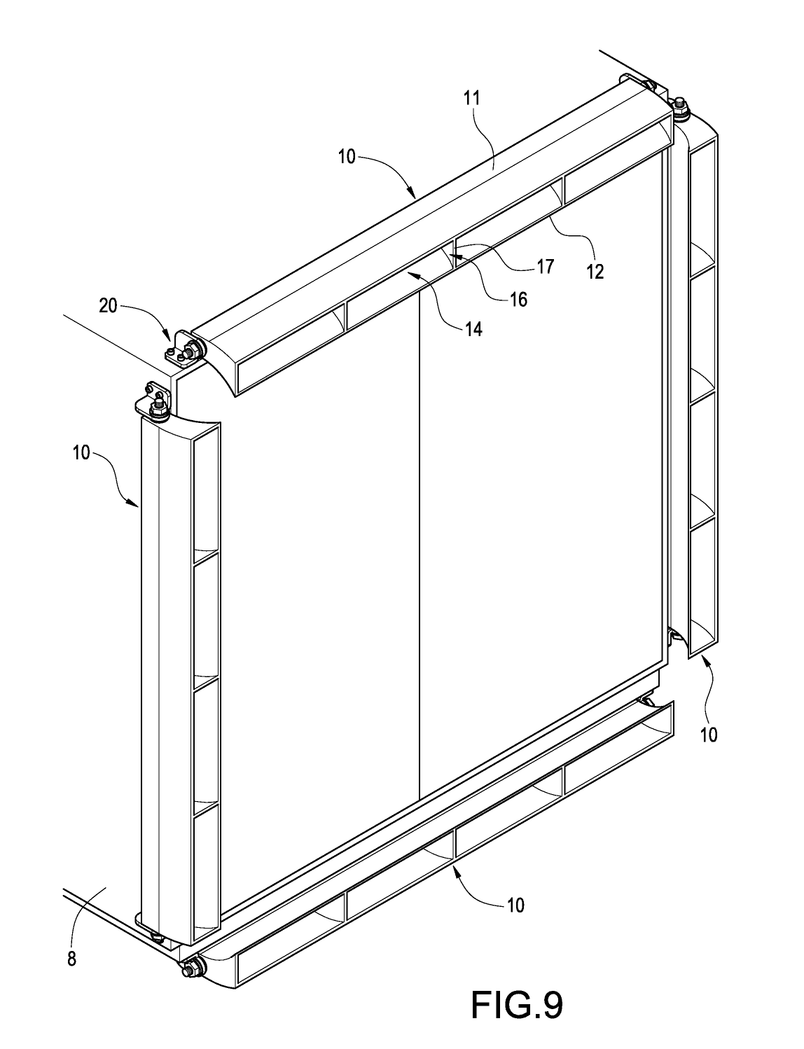

Further refer to FIG. 8 and FIG. 9. In FIG. 8, based on different requirement and running status, this kind of nozzle-typed drag-reducing structure can be arranged at two lateral positions (i.e., left and right sides) at the tail end of the vehicle 8. Or, as shown in FIG. 9, the drag-reducing structure can also be arranged at four lateral positions (i.e., upper, lower, left and right sides) at the tail end of the vehicle 8, whereby the drag forces generated from each directions can be reduced.

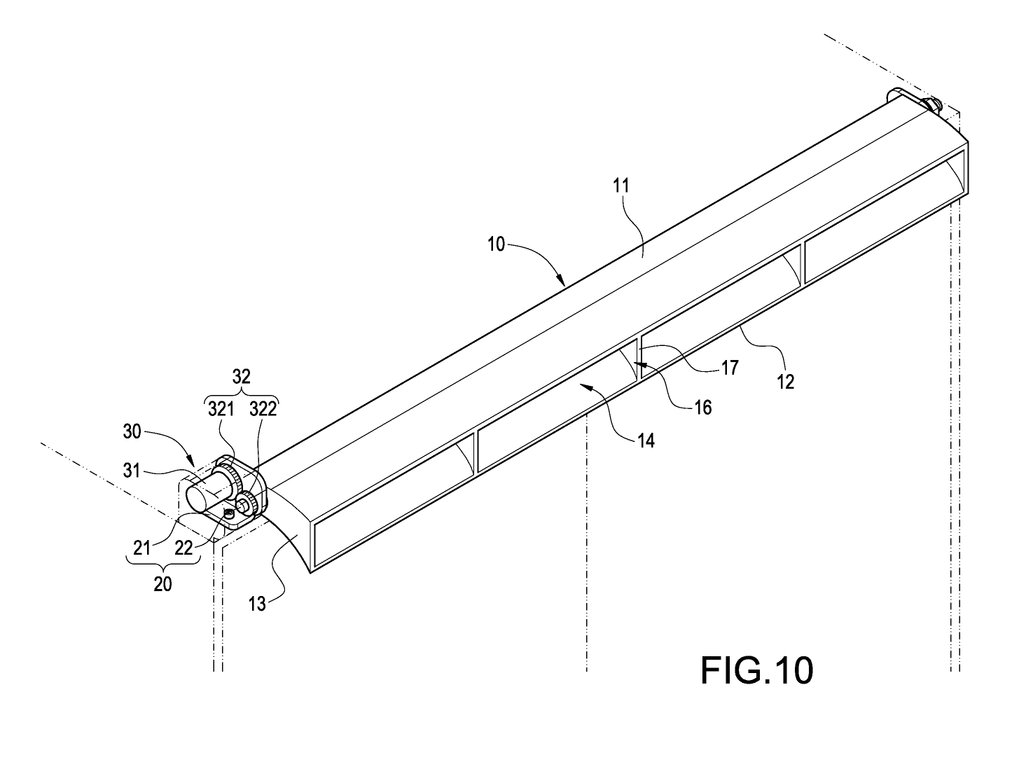

As shown in FIG. 10, except the embodiments configured thereinbefore, the nozzle-typed drag-reducing structure can further include a driving assembly 30 including a motor 31 and a gear set 32. In this assembly, the motor 31 is fixed onto the “L”-shaped angular plate 21, while the gear set 32 is comprised of two gears 321, 322, which have two different diameters and are engaged to each other to form a transmission. In this case, the gearwheel 321 is fitted onto the mandrel of the motor 31 and activated thereby, while the pinion 322 is fitted onto the pivot 22 to be activated. When intending to open the rear door of the vehicle 8, by means of the rotation of the mandrel of the motor 31, the gearwheel 321 transmits a rotation to the pinion 322, which in turn rotates the pivot 22. Thereby, the frame body 10 is lifted up by taking the pivot 22 as a rotational center. Thus, the rear door of the vehicle 8 can be opened easily.

Accordingly, through the constitution of aforementioned assemblies, a nozzle-shaped drag-reducing structure for vehicle according to the invention is thus obtained.

Summarizing aforementioned description, the nozzle-shaped drag-reducing structure is an indispensably design for vehicle indeed, which may positively reach the expected usage objective for solving the drawbacks of the prior arts, and which extremely possesses the innovation and progressiveness to completely fulfill the applying merits of a new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. A nozzle-typed drag-reducing structure for vehicle, which is adapted to be arranged at a tail end of a vehicle and includes: a frame body comprised of a combination of a plurality of deflectors, between two of which an airflow channel is formed; and an air inlet and an air outlet respectively formed at two sides of the frame body, and which is characterized in that the area comprised by surrounding the air outlet is larger than the area comprised by surrounding the air inlet.

2. The nozzle-typed drag-reducing structure for vehicle according to claim 1, wherein the frame body includes an upper deflector, a lower deflector disposed by corresponding to the upper deflector and two lateral deflectors connecting the upper deflector and the lower deflector.

3. The nozzle-typed drag-reducing structure for vehicle according to claim 2, wherein the upper deflector and the lower deflector are all configured as an arc shape.

4. The nozzle-typed drag-reducing structure for vehicle according to claim 3, wherein a curvature radius of the upper deflector is larger than that of the lower deflector.

5. The nozzle-typed drag-reducing structure for vehicle according to claim 4, wherein the upper deflector, the lower deflector and the lateral deflectors are constructed integrally.

6. The nozzle-typed drag-reducing structure for vehicle according to claim 2, wherein the frame body further includes a plurality of separating plates which are disposed in parallel to the lateral deflectors and are interspaced to each other by being accommodated in the airflow channel.

7. The nozzle-typed drag-reducing structure for vehicle according to claim 1, further including a pair of connecting assemblies which are respectively fixed to the vehicle for connecting the frame body.

8. The nozzle-typed drag-reducing structure for vehicle according to claim 7, wherein each connecting assembly includes an “L”-shaped angular plate fixed to the vehicle and a pivot, one side of which is fixed to the frame body, while another side is pivoted to the “L”-shaped angular plate.

9. The nozzle-typed drag-reducing structure for vehicle according to claim 8, further including a driving assembly which includes a motor fixed to the “L”-shaped angular plate and a gear set fitted to a mandrel of the motor and inter-engaged with the pivot to form a transmission.

10. The nozzle-typed drag-reducing structure for vehicle according to claim 7, wherein each connecting assembly includes an “L”-shaped angular plate fixed to the vehicle, a screw, one side of which is fixed to the frame body, while another side penetrates the “L”-shaped angular plate, and a locking element screwing and abutting the screw correspondingly.
